(19) United States
(12) Patent Application Publication
(10) Pub. No.: US 2018/0007461 A1
(43) Pub. Date: Jan. 4, 2018

(54) In-Ear Headphone For Gaming, High Fidelity Music and 3D Effect

(71) Applicant: Tack Ching Wun, Ngau Chi Wan (HK)

(72) Inventor: Tack Ching Wun, Ngau Chi Wan (HK)

(21) Appl. No.: 15/641,562

(22) Filed: Jul. 5, 2017

Related U.S. Application Data
(60) Provisional application No. 62/358,091, filed on Jul. 4, 2016.

(51) Int. Cl. H04R 1/10; H04S 7/00; H04R 5/033; H04R 3/04; G10K 11/178

(52) U.S. Cl. CPC H04R 1/1041; H04R 3/04; H04R 1/1016; G10K 11/1786; H04R 5/033; H04S 7/304; G10K 2210/1081; G10K 2210/3046; H04S 2400/13; H04S 2420/01

(57) ABSTRACT

A multi-purpose earphone having a vocal enhancement at 150 Hz and 2.4 kHz and having an inline dongle mechanism for toggling sound effects for playing games, watching movies, and listening to high fidelity musics.

### CROSS-REFERENCE

Priority is claimed from the US Provisional Patent Application No. 62/358,091 filed on Jul. 4, 2016, entitled “Game HiFi and 3D Headphone,” the entirety of which is incorporated by reference.

### BACKGROUND

### Field of the Invention

This invention relates to the field of earphones, specifically to an in-ear headphone that provides a dongle for toggling between sound effects for gaming, high fidelity sound quality for playing music and 3D surrounding sound effects for movies.

In-ear headphones are convenient and comfortable because of their light weight and small sizes. However, because of their limited space and size, it is also very challenging to provide high fidelity sound out-put and 3D effect with in-ear headphones. The specific challenge is that a large portion of the speaker is placed within the ear canal, this limits the available options for sound improvement.

Due to the structure of the headphones, often the bass-frequency is depressed. There have been many attempts to provide high fidelity and sounding effects to headphones. For example, US Patent Publication. No. 2001/0048378 A1 provides booster designs with switches for switching between low frequency and high frequency boosting. U.S. Pat. No. 7,590,258 describes a solution by providing a sound tuning means with the speaker. U.S. Pat. No. 8,498,426 includes a circuit that keeps a voice ratio at a level so that the chat-voice volume level increases proportionately to the game-audio volume level. Most of the in-ear headphones are for single purpose use only.

With the very limited size, the added functions make it impossible to use a flexible bass-booster circuit that switches between boosting low frequency sounds and high frequency sounds. New bass booster must be designed. However, if an in-earphone is to be used for multiple purposes that provide 3D effect for playing games, provide high fidelity sound quality for listening to music and provide a side-tone effect for the quality of sound, it is unknown what vocal boosting practice would function well with all of these sound effects integrated together.

The present application provides such an in-ear headphone device design that has elegantly integrated multi-functional components for different sound effects.

### SUMMARY

The present application discloses a multi-function in-ear headphone device for gaming, music high fidelity listening, and a 3D immersive experience. With the addition of extra functions, it is impossible to provide a flexible bass-booster circuit that switches between boosting low frequency sounds and high frequency sounds.

In one embodiment, a vocal enhancer circuit of two filters (bass-boosters) that simultaneously boosts the 150 Hz and the 2.4 KHz to strengthen and brighten the sounds is provided.

In another embodiment, a 24 bit/96 Khz decoding chip is coupled with a 10 Hz to 40 KHz digital processor such as PCM1793 DAC to provide high fidelity music playback with a −110 dB noise floor.

In another embodiment, bass-boosters are provided both left and right channels respectively, then signals from left and right channels are cross-fed and adjusted with phase shift to provide simulation of 3D surround sound.

In another embodiment, a microphone and microphone amplification circuit is built with the in-ear headphone to collect voice of the user to provide a natural audio feedback of a user's own voice, the preferred volume is 5+/−3 dBm.

In another embodiment, a sound output volume circuit is built into the circuit to limit output of sound volume to be less than 94 dBspl sound pressure level.

In another embodiment, an Active Noise Cancellation component is built into the circuit, wherein environment noises at the left and right ears are collected through the microphones at the left and right ears and are measured, if the ambient noise level is greater than 30 dB, a filter is automatically turned-on to keep the signal to noise output around 80 dB, the filter is turned-off if the ambient noise level is less than 30 dB or the signal volume is more than 92 dBspl.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1A shows an example double-filter circuit diagram for simultaneous vocal enhancement at 150 Hz and 2.4 KHz in accordance with this application.

FIG. 1B shows a frequency specific vocal enhancement with the double-filter circuit of FIG. 1A.

FIG. 2 shows an example 24 bit/96 kHz high fidelity decoding and 10 Hz-40 KHz digital signal processing circuit for output sound signals of low noise floor in accordance with this application.

FIG. 3 depicts an example circuit diagram for providing sidetone effect to the earphone in accordance with this application.

FIG. 4 shows an example circuit diagram for limiting the sound output volume to be at 94 dBspl in accordance with this application.

FIG. 5 shows an example circuit diagram for Automatic Active Noise Cancellation in accordance with this application.

FIG. 6 shows an example in-ear headphone with an in-line control dongle to switch between different sound out-puts from various set of circuits in accordance with this application.

FIG. 7 shows an example diagram for providing 3D sounds in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the following figures illustrate the general manner of construction, and description and details of well-known features and techniques that may be omitted to avoid unnecessarily obscuring the invention. Additionally, elements in the figures are not necessarily drawn to scale; some areas or elements may be expanded to help improve understanding of the embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

Background knowledge and the meaning and boundaries of the technical terminologies shall be constructed and interpreted according to the custom uses in the electronic engineering field and particularly in the field of acoustics and in the field of audio signal processing.

The term “in-ear earphone or headphone” refers to a small speaker that can be worn in or around a human ear with an inline cable that provides a dongle component for toggling between various sound output effects; such as effects for gaming, high fidelity music playbacks, and for a 3D immersive effect.

The term “high fidelity unit or circuitry” refers to a digital sound decoding and processing unit that is capable of decoding high density (24 bit/96 KHz) digital sound data.

The term “3D surround sound effect” refers to the effect of cross-feeding between left channel and the right channel with a phase shift to produce the simulation of 3D surround sound.

The term “sidetone effect” refers to the effect produced by using a microphone to collect the voice of the user and feedback a low volume of the voice to the earphone speaker.

The term “Healthy Mode” refers to the component of the headphones that limits the sound output to 94 dBspl.

The term “Active Noise Cancellation” refers to the automatic removal of background noise when the measured ambient noise is higher than 30 dB or the signal to noise difference is less than 80 dB.

All smartphones now playback audio signals for various usages such as gaming, music listening and movie watching. It is desirable to have an in-ear headphone that produces different sound effects according to different usages.

With the very limited space, it is very challenging to compact various functional component into a housing body that is light and small size to be wearable on an ear. The added functions make it impossible to use a flexible bass-booster circuit that switches between boosting low frequency sounds and high frequency sounds.

With testing and trials, the inventors discovered that the boosting input at 150 Hz together as well as at 2.4 HKz works well with the desired effects for gaming, high fidelity playback and cross-feeding of channels for 3D effects. Boosting up input audio signals at the 150 Hz makes the vocal input stronger and thicker which works well for 3D effect and high fidelity music play back, but boosting up input audio signals at 2400 Hz makes the vocal input brighter for gaming effects. Both of these two boostings generate good effect for all subsequent signal manipulation.

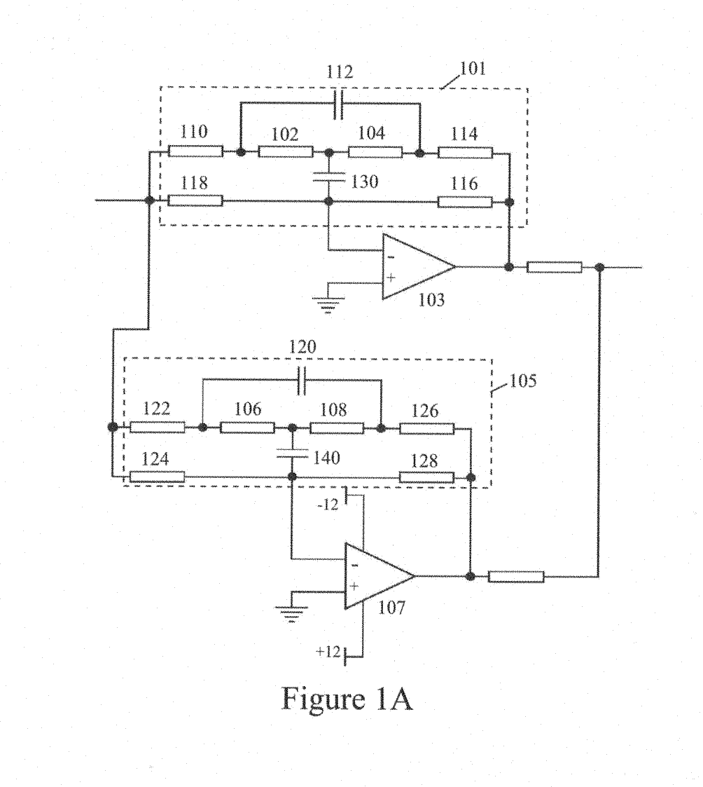

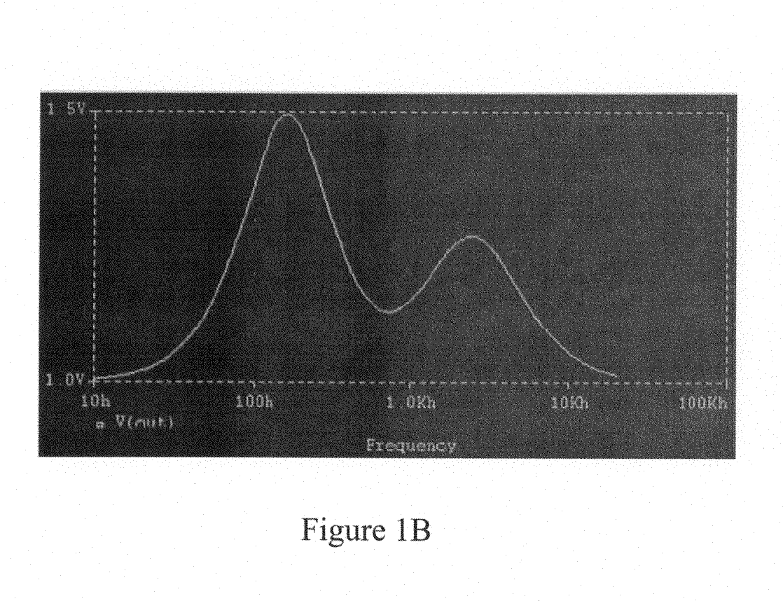

In reference to FIG. 1A, two filters 101 and 105 are paralleled to provide simultaneous two frequency boosting at 150 Hz and 2.4 KHz. They also form nested feedback loops with two JFET dual operational amplifiers 103 and 107, making the whole unit behave more like an ideal voltage source, reducing distortion. The resistor and capacitor values in filters 101 and 105 determine the boosting and cut-off frequency. For example, capacitor 112 allows for frequency to by-pass the resistors 102 and 104 to provide a boost at higher frequency, and similarly for capacitor 120 to allow for frequency to by-pass the resistors 106 and 108 to provide a boost. The addition of capacitors 130 and 140 allow for the pass of low frequencies and the attenuation of high frequencies. In the example circuit, with resistors 110, 114, 122 and 126 being at 10 kΩ, resistors 118, 116, 124, 128 being at 1MΩ, 102 resistor to be 33 kΩ and 104 resistor to be 68 kΩ, and resistor 106 being 22 kΩ and resistor 108 being 75 kΩ, capacitors 112 and 130 being at 222 uF and capacitors 120 and 140 being at 333 uF, the amplifiers being TL-082, with bias (−12V and +12V) at amplifier 107, a smooth and stable boosting at both 150 Hz and 2.4 KHz is generated as shown in FIG. 1B.

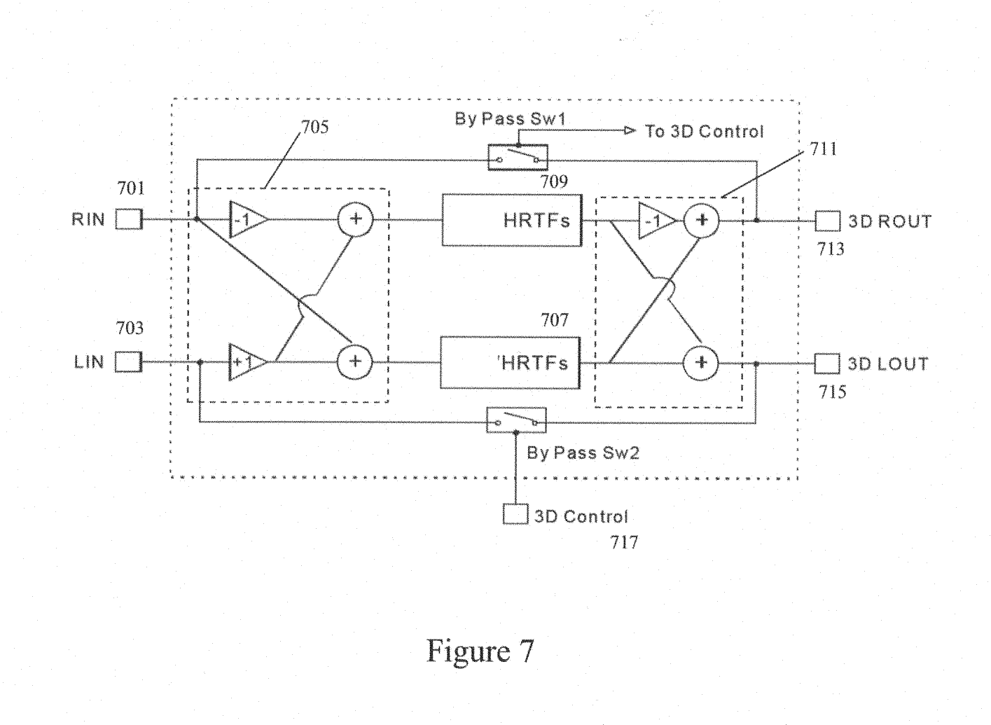

The boosted output audio signals can be used as input signals fed to a left channel and a right channel, and the signals in each channel can then go through a cross-feeding circuitry with HRTF filters for 3D sound effect as shown in FIG. 7. There are state of art and commercially available technology for simulating of signal cross-feeding circuitry with HRTF filters, chips such as PT2387 Audio Processor IC from Princeton Technology Corporation. Details of such signal cross-feeding circuitry with HRTF filters is thus omitted.

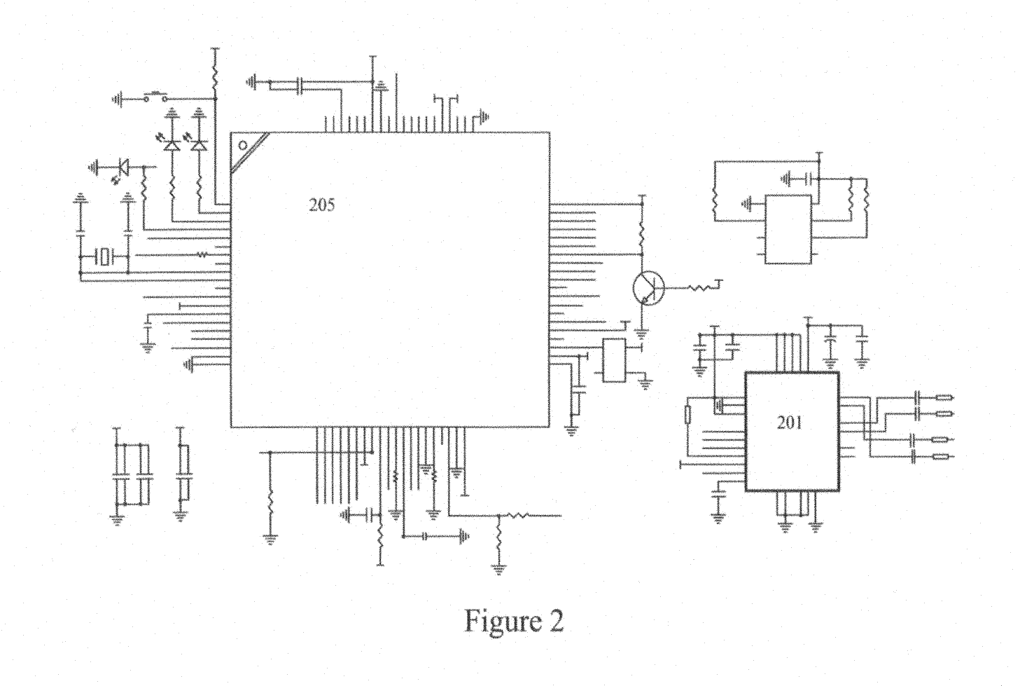

Before audio signals entering the circuitry of FIG. 1A for boosted output, digital input signals may be first manipulated for various effects. In order to have high fidelity playback, an independent circuit for decoding high density digital audio signals are built with OTK5262 chip in combination with PCM1793 DAC chip. OTK5262 chip provides 24 bit/192 KHz decoding driver and PCM1793 DAC chip provides 24 bit/192 kHz digital to analog converter. An example circuitry is shown in FIG. 2. With this, the noise floor would be down to −110 dB. The PCM1793 DAC chip set 201 provides balanced voltage outputs, sampling rates up to 20 kHz and a dynamic range of 113 dB.

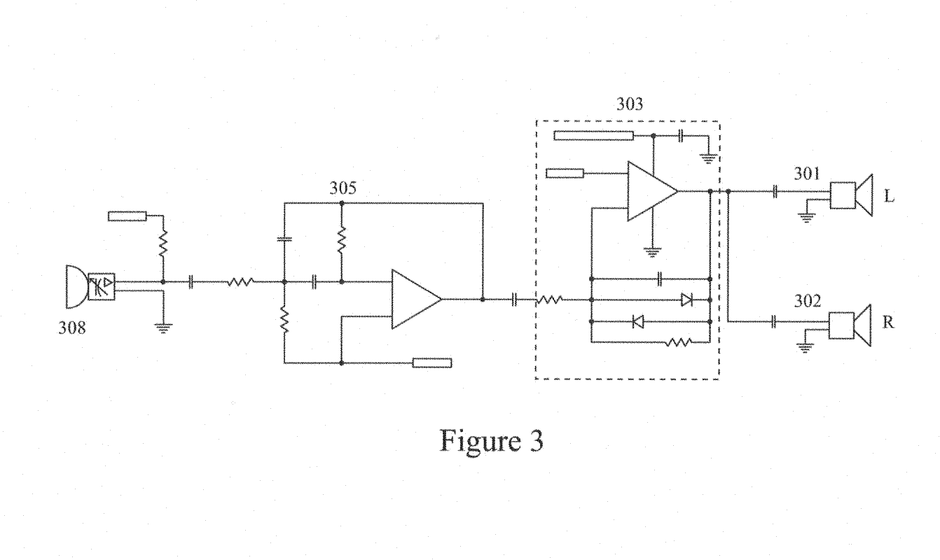

In addition, a side-tone capability can be added to the output circuitry of FIG. 1A by adding a feedback circuitry from the microphone to the earphone speakers as shown in FIG. 3. The voice collected from microphone 308 is amplified and limited to the level 0f 5+/−3 dBm through blocks 305 and 303, then is fed back to speakers L 301 and R 302. Two TS9224 chips may be used for the amplification and limitation circuit blocks 305 and 303.

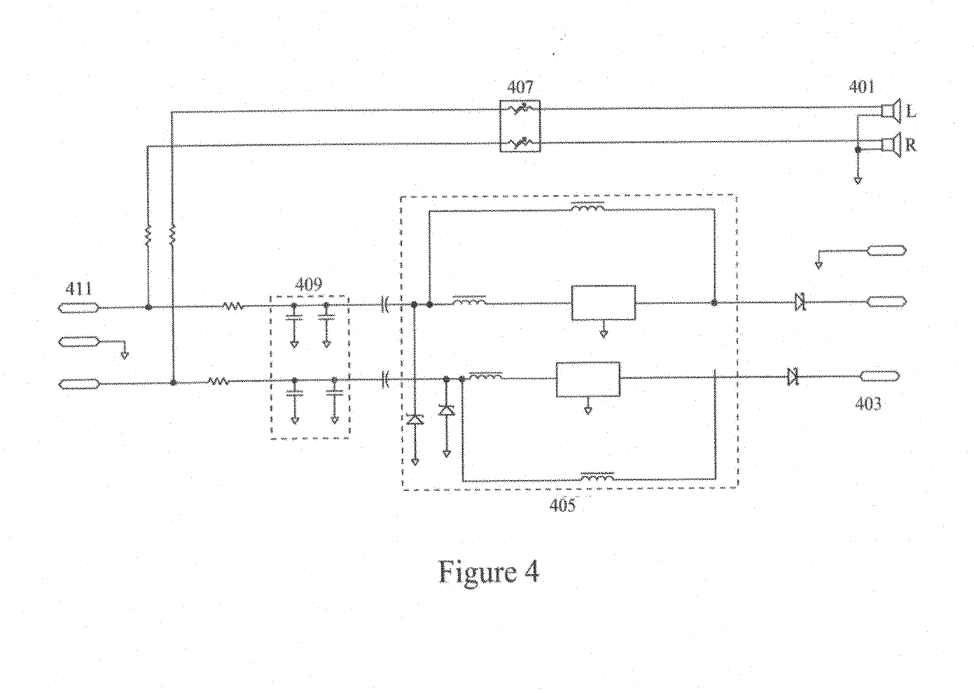

In reference to FIG. 4, circuit blocks 405, 407 and 409 may be added to the output circuitry of FIG. 1A to limit the volume output to be less than 94 dB. The signals are transmitted through resistors, non-polarized and fixed capacitors, a pair of diodes, inductors and amplifiers in which the sound signals can be altered and limited to an output level of less than 94 dB for healthy listening. Final output audio signals are received on both the left and right speakers 401.

To improve sound quality many earphones have constant noise cancellation installed in the circuitry, but constant noise cancellation can also cause sound quality to decline when the noise is very low or when the sound volume is sufficiently high. To solve this problem, a unique Automatic Active Noise Cancellation (A2NC) unit is designed into the speaker circuitry. A2NC will turn off noise cancellation when the output sound volume is more than 92 dB or when the background ambient noise is less than 30 dB.

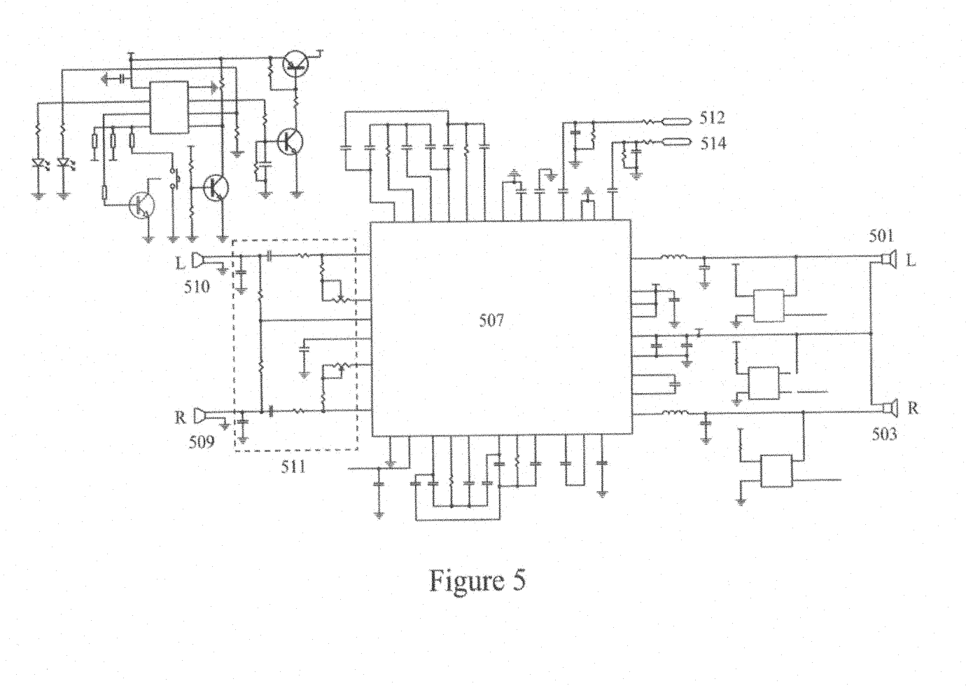

In reference to FIG. 5, the circuit diagram for the A2NC component can be added to end of the output circuitry of FIG. 1A. Ambient noise levels at the left and right earphones are collected at 2 pairs of small microphones 510 and 509, and are transmitted through Active Noise Canceling Headphone Subsystem chipset MAX9895 (507) for processing. The MAX9895 features three modes of operation active noise canceling (ANC) on or off, and push-to-listen (PTL). The ANC-on mode provides full noise canceling and provides line-input mixing to the headphones. By linking the micro-phone with a control unit 511, when the noise from microphones 510 or 509 are less than 30 dB or the output volume at the speakers are greater than 92 dB, the control unit 511 turns on the ANC-off mode that disables the micro-phone preamplifiers and noise processing blocks, but allows the line inputs 512 and 514 to operate normally. When the noise is greater than 30 dB and the output volume is less than 92 dB, control unit 511 is connected with the ANC-on mode for full noise cancellation.

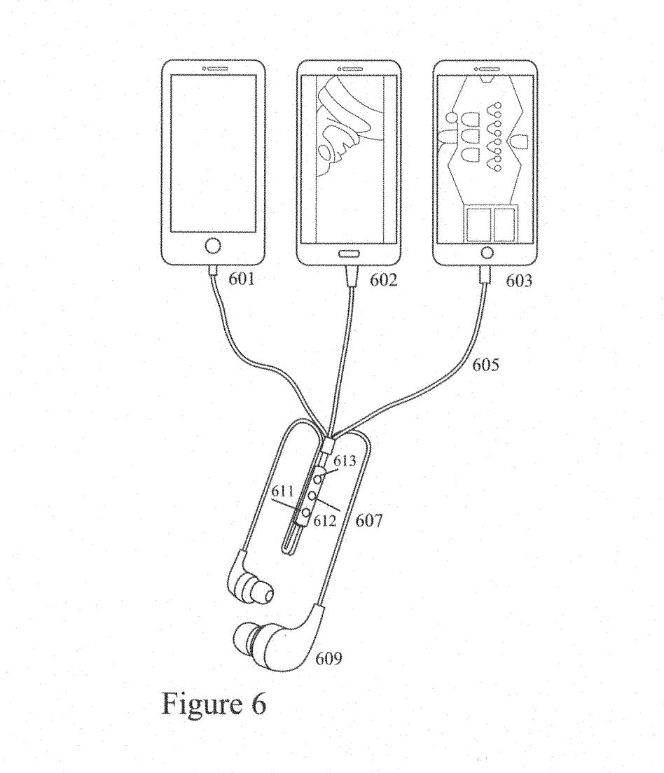

In reference to FIG. 6, an in-ear headphone with inline dongle buttons for switching between different output modes are displayed. Input device 601 is for high fidelity music playing, input device 602 for 3D effect of watching a movie and device 603 for playing games. By pressing dongle button 611, both input audio signals will not be sent to the circuitry described in FIG. 7 and in FIG. 2, but the input signals will be vocally enhanced at 150 Hz and 2.4 KHz, this produces good effects for playing games. By pressing dongle button 612, the input signals will be sent to circuitry in FIG. 2 for 24 bit/192 k decoding, and then converted into analog signals before being sent for vocal enhancement circuitry in FIG. 1 for output. By pressing dongle button 612, the input signals will be sent to circuitry in FIG. 2 for 24 bit/192 k decoding, and then converted into analog signals before being sent for vocal enhancement circuitry in FIG. 1 for output.

None of the descriptions in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle. The claims as filed are intended to be as comprehensive as possible, and NO subject matter is intentionally relinquished, dedicated, or abandoned.

What is claimed is:

1. An in-ear headphone for multi-purpose uses, having a left speaker for the left ear of a human and a right speaker for the right ear of a human, comprising:
a circuitry for boosting output audio signals both at 150 Hz frequency and at 2.4 KHz frequency; and
an inline dongle mechanism configured on an input cable for sending input signals into a specific processing circuitry.

2. The in-ear headphone of claim 1, wherein said circuitry for boosting output audio signals comprises two boosting filters.

3. The in-ear headphone of claim 2, wherein said circuitry for boosting output audio signals further comprises two TL-082 or its equivalent amplifiers.

4. The in-ear headphone of claim 1, further comprising a circuitry for decoding 24 bit/192 kHz digital signals, a dongle in said inline dongle mechanism being configured to send high-fidelity audio digital signals into said circuitry for decoding 24 bit/192 kHz digital signals for processing and generating input signals for said circuitry for boosting.

5. The in-ear headphone of claim 4, wherein said circuitry for decoding 24 bit/192 kHz digital signals comprises an OTK5262 chip or an equivalent type of chip in combination with a PCM1793 DAC chip or an equivalent type of chip.

6. The in-ear headphone of claim 1 further comprising a circuitry for cross-feeding between a left input channel and a right input channel and for adjusting phase shift with HRTF, producing simulation of 3D surround sound signals; and a dongle in said inline dongle mechanism being configured to send audio signals into said circuitry for cross-feeding for 3D simulation output.

7. The in-ear headphone of claim 6, wherein said circuitry for cross-feeding comprises a PT2387 chip or its equivalent.

8. The in-ear headphone of claim 1, further comprising a circuitry for receiving a voice signal from a microphone connected with said in-ear headphone, and for generating and sending a 5+/−3 dBm feedback signal of said voice signal to the left and right speakers.

9. The in-ear headphone of claim 1, further comprising a circuitry for limiting output signal volume to less than 92 dBspl.

10. The in-ear headphone of claim 1, further comprising an automatic active noise cancellation unit including a MAX9895 or an equivalent chip set for turning off noise cancellation when noise level is below 30 dB or output sound volume is higher than 92 dBspl.

11. The in-ear headphone of claim 10, wherein said automatic active noise cancellation unit comprises a control circuit unit linked with an ANC-off mode and an ANC-on mode of said MAX9895 or an equivalent chip set.
